(19) United States
(12) Patent Application Publication
(10) Pub. No.: US 2010/0017554 A1
(43) Pub. Date: Jan. 21, 2010

(54) SYSTEM AND METHOD FOR MANAGING A PLUGGED DEVICE

(75) Inventor: Yuan-Heng Sun, Taipei County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, Hsinchu (TW)

(21) Appl. No.: 12/248,329

(22) Filed: Oct. 9, 2008

(30) Foreign Application Priority Data
Jul. 17, 2008 (TW) TW097127111

(51) Int. Cl. G06F 12/02

(52) U.S. Cl. 711/103; 711/E12.008

(57) ABSTRACT

An electronic device is provided including a non-volatile memory, a connection interface, a processor and at least one resource. The at least one resource has at least one configuration. The non-volatile memory stores the configuration for the resource. The processor generates the configuration for the resource. When plugged into the host device through the connection interface, the electronic device receives a request from the host device and performs an operation in the resource using the configuration.

### CROSS REFERENCE TO RELATED APPLICATIONS

This Application claims priority of Taiwan Patent Application No. 097127111, filed on Jul. 17, 2008, the entirety of which is incorporated by reference herein.

### BACKGROUND OF THE INVENTION

1. Field of the Invention

The invention relates to a system and method for managing a plugged device, and more particularly to a system and method for managing a plugged device with I/O modules without installing a driver corresponding thereto.

2. Description of the Related Art

Flash memories are widely used as storage units in current embedded systems or electronic devices, such as handheld or portable electronic devices including smart phones, personal digital assists (PDAs), tablet PCs or Ultra Mobile PCs (UMPCs), PCs and NBs. As embedded systems or electronic devices with Flash memories became popular, more and more I/O modules, such as an MP3 player module, a GPS module, a card reader module, a wireless module (e.g. a blue-tooth earphone module) or a finger recognized module, were combined and embedded together with the Flash memory into the system.

For the embedded systems or portable devices with I/O modules, corresponding drivers of the required I/O modules have to be installed first, in order to use or control the I/O modules. Thus, time and costs are expended when attempting to develop or locate a driver for a particular I/O module, and are compounded for less popular I/O modules. Furthermore, a driver of a required I/O module has to be modified, if new features are added to the required I/O module. Modification of the driver, however, is not easy and requires professional skills.

### BRIEF SUMMARY OF THE INVENTION

In exemplary embodiment consistent with the present invention, there is provided a electronic device comprises a non-volatile memory, a connection interface, a processor and at least one resource. The each one of the resource has at least one configuration. The non-volatile memory stores the configuration for the resource. The processor generates the configuration for the resource. When plugged into the host device through the connection interface, the electronic device receives a request from the host device and performs a corresponding operation in the resource using the configuration.

In exemplary embodiment consistent with the present invention, there is provided a method for managing an electronic device plugged into a host device, wherein the electronic device has at least one resource. First, each one of the resource for the corresponding configuration is generated when detecting that the electronic device has been plugged into the host. Then, the resource is selected and directed to perform an operation corresponding to the configuration using the configuration of the selected resource.

In exemplary embodiment consistent with the present invention, there is provided a method for managing an electronic device, wherein the electronic device has at least one resource. First, the corresponding configuration for the resource is provided. Next, a host device is plugged into and the configuration for the resource is generated. Thereafter, a request from the host device is received. Finally, an operation is performed in a selected resource using the configuration corresponding to the selected resource.

### BRIEF DESCRIPTION OF THE DRAWINGS

The invention can be more fully understood by reading the subsequent detailed description and examples with references made to the accompanying drawings, wherein:

FIG. 1 shows an exemplary embodiment of a system for managing a plugged device.

FIG. 2 is a flowchart of a method for managing an electronic device plugged into a host device, according to exemplary embodiments.

FIG. 3 is a flowchart of a method for generating configurations of each resource in the host device, according to exemplary embodiments.

FIG. 4 shows an exemplary embodiment of generated configurations of an audio codec module and a radio frequency (RF) module.

FIG. 5 is a flowchart of a method for performing a request to perform an operation in the plugged device, according to exemplary embodiments.

FIG. 6 shows an example of inputting a predetermined command in a command mode.

FIG. 7 is another flowchart of a method for performing an operation in the plugged device, according to exemplary embodiments.

FIG. 8 shows another exemplary example for managing an electronic device plugged into a host device.

### DETAILED DESCRIPTION OF THE INVENTION

The description is made for the purpose of illustrating the general principles of the invention and should not be taken in a limiting sense. The scope of the invention is best determined by reference to the appended claims.

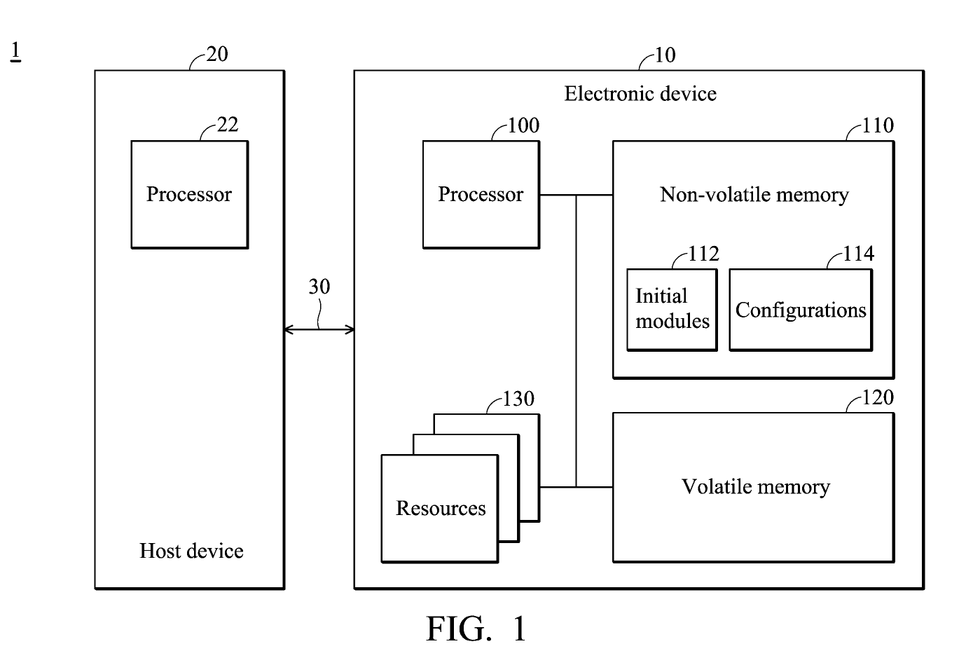

FIG. 1 shows an exemplary embodiment of a system for managing a plugged device. The system 1 comprises an electronic device 10 and a host device 20. The electronic device 10 is a pluggable device and is manageable by the host device 20 when it is plugged into the host device 20 through a connection interface 30, such as a universal serial bus (USB) interface. The host device 20 may be, for example, handheld or portable electronic devices, such as smart phones, personal digital assists (PDAs), tablet PCs or Ultra Mobile PCs (UMPCs), or a computer system such as a personal computer (PC) or a notebook (NB). The electronic device 10 at least comprises a processor 100, a non-volatile memory 110, a volatile memory 120 and at least one resource 130. The non-volatile memory 110 (e.g. flash memory) can store data or application programs. Accordingly, the processor 100 can execute a computer program performing a method for managing an electronic device plugged into the host device. The resources 130 may be I/O modules or devices such as an audio codec module (e.g. a MP3 player module), a Global Positioning System (GPS) module, a card reader module, a wireless module (e.g. a blue-tooth earphone), a handwriting recognition module or a finger recognition module, but it is not limited thereto. Note that the resource 130 may also be embedded into the non-volatile memory 110 in other embodiments.

The non-volatile memory 110 stores initial modules 112 (e.g. applications) that correspond to the resource 130. Each initial module 112 corresponds to the resource 130 and has information regarding the generation of configurations 114 of the corresponding resource. When plugging into the host device 20, the resource 130 is controlled and operated by the host 20. The volatile memory 120 may store the computer program and be accessed by the processor 100, such as a dynamic random access memory (DRAM), a static random access memory (SRAM), or others.

The host device 20 may comprise necessary components or hardware like the electronic device 10, such as a processor 22, for executing a computer program to perform a method for managing a plugged device so as to use the resources of the plugged device.

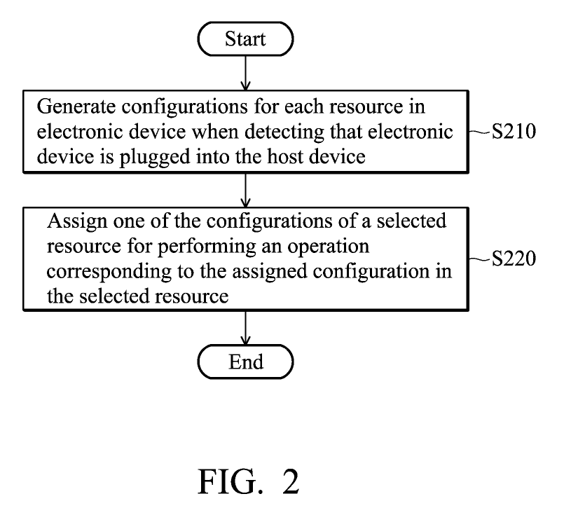

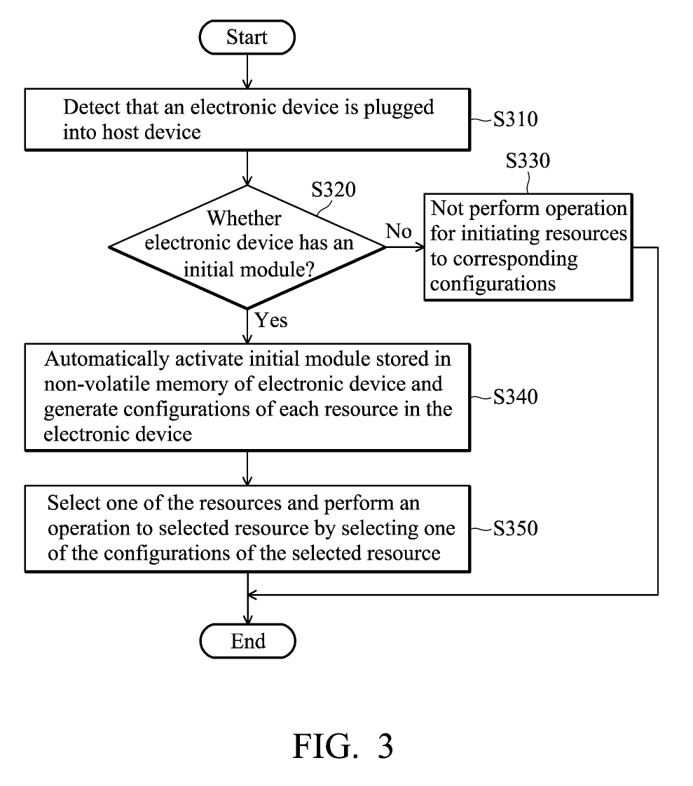

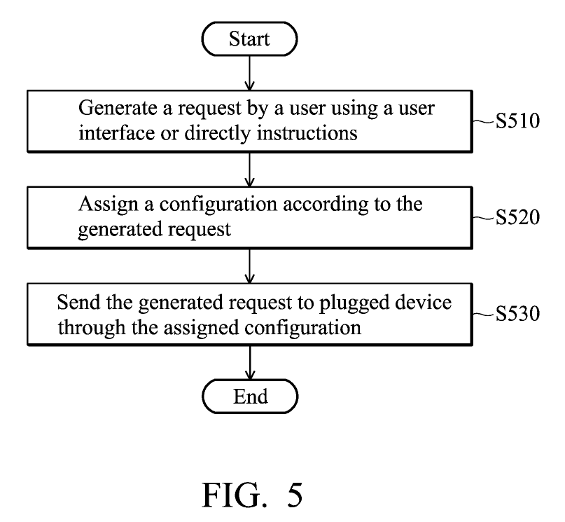

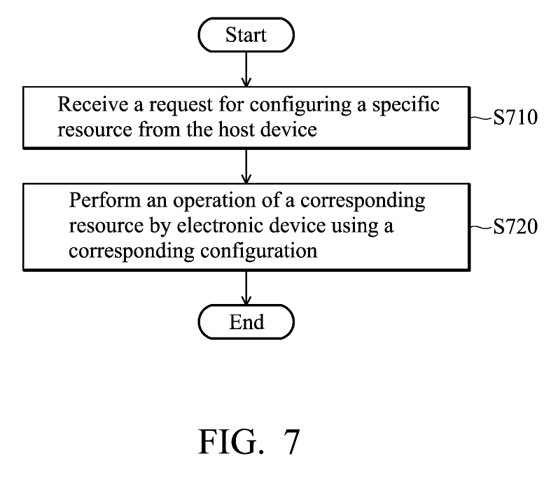

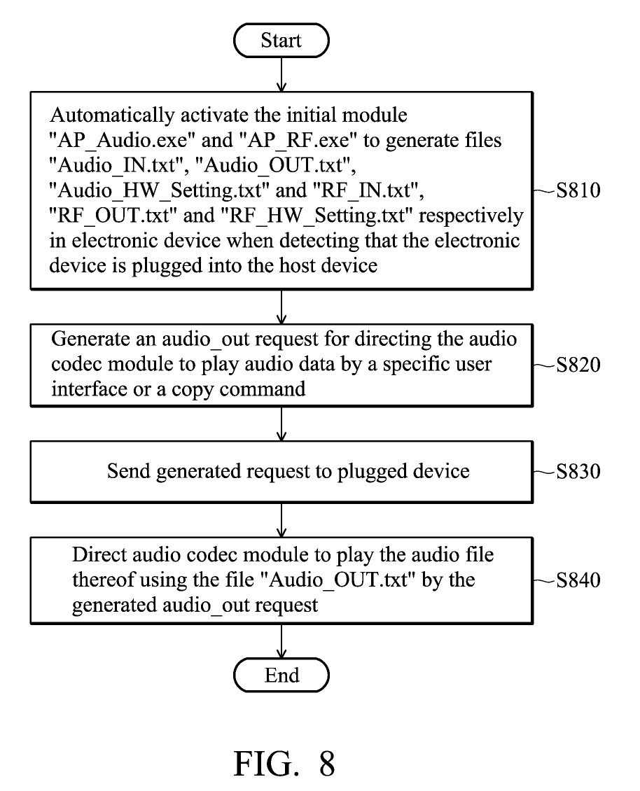

FIG. 2 is a flowchart of a method for managing an electronic device plugged into a host device, according to exemplary embodiments, and the method can be stored in a computer program and executed by a processor of the host device as described in FIG. 1. Referring to FIG. 1, the electronic device 10 has at least one resource 130. First, in step S210, at least one configuration 114 for the resource 130 are generated when detecting that the electronic device 10 is plugged into the host device 20. Then, in step S220, the configurations 114 of a selected resource 130 is assigned and executed for performing a corresponding operation. Following, step S210 will be described with reference to FIGS. 3 and 5, and step S220 will be described with reference to FIGS. 7 and 8.

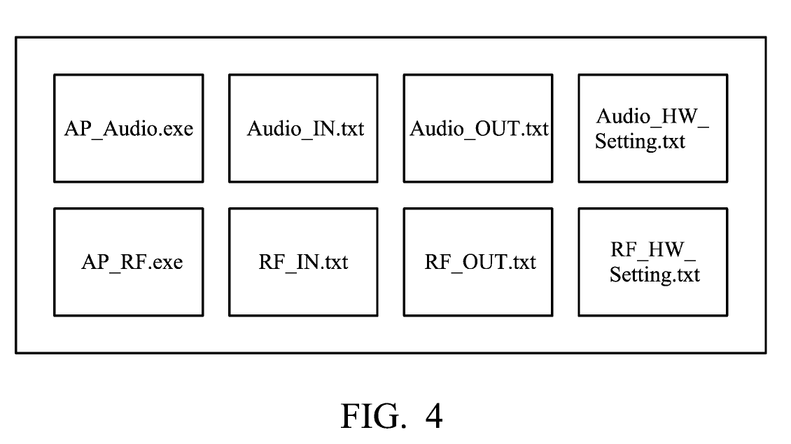

FIG. 3 is a flowchart of a method for generating configuration of each resource in the host device as shown in step S210 of FIG. 2. Note that the method can be stored in a computer program and executed by a processor 22 in the host device 20 as described in FIG. 1. Referring to FIGS. 1 and 3, it is assumed that the electronic device 10 does not plug into the host device 20 yet at initial. The electronic device 10 (e.g. electronic device described in FIG. 1) is plugged into the host device 20 (e.g. host device described in FIG. 1) and it is detected by the processor 22 (step S310). In response, whether the electronic device 10 has an initial module is inspected (step S320). If no initial module can be found in the electronic device 10 (No in step S320), an operation for initiating the resources 130 to corresponding configurations will not be performed and the flow ends (step S330). Contrarily, if an initial module 112 has been found in the electronic device 10 (Yes in step S320), steps S340-S350 are further performed. The found initial module 112 stored in the non-volatile memory 110 of the electronic device 10 are automatically activated and configurations 114 of the resource 130 are generated in the electronic device 10 (step S340). Note that the resource 130 may configure to a plurality of configurations 114 according to functionality or features of the resource. Following, the generation process of the configurations of a resource is described with reference to FIG. 4. Next, one of the resources 130 is selected and an operation is performed to the selected resource by selecting one of the configurations of the selected resource (step S350).

It is to be noted that, in step S340, the initial module 112 may further generate configurations 114 of the resource 130 corresponding to current running operating system (OS) environment based on the running operating system environment.

Note that, after performing step S340, a new drive can be found (e.g. a removable drive is displayed) in the host device 20, but no driver is needed to be installed. By doing so, in this embodiment, when the electronic device 10 has plugged into the host device 20, the resource 130 of the electronic device 10 can be configured to corresponding files (e.g. configurations) such that user may use these files to issue a control command to use any resource of the electronic device 10 or read/write data therefrom/thereto. Therefore, the method of FIG. 2 or FIG. 3 can be applied in a driverless device or a device whose driver is unknown.

FIG. 4 shows an exemplary embodiment of generated configurations of an audio codec module and a radio frequency (RF) module. As shown in FIG. 4, an audio codec module(resource) may be configured to a plurality of configurations such as an input file (i.e.“Audio_IN.txt”) for representation of data inputting, an output file (i.e. “Audio_OUT.txt”) for representation of data outputting and a hardware setting file (i.e. “Audio_HW_Setting.txt”) for representation of the hardware setting thereto. In this embodiment, if a user request (e.g. a request for voice recording) is received, audio data can be inputted into the audio codec module by the input file (“Audio_IN.txt”) and outputted by the audio codec module by the output file (“Audio_OUT.txt”). And, hardware settings of the audio codec module can be configured by the hardware setting file (“Audio_HW_Setting.txt”). By an initial module (i.e. “AP_Audio.exe”) of the audio codec module which comprises information regarding the generation of configurations for the audio codec module, the input file (“Audio_IN.txt”), the output file (“Audio_OUT.txt”) and the hardware setting file (“Audio_HW_Setting.txt”) can be generated.

Similarly, a wireless module (e.g. a radio frequency (RF) module) may be configured to a plurality of configurations such as a transmission file TX (i.e. “RF_OUT.txt”) for representation of the data to be transmitted, a receiving file RX (i.e. “RF_IN.txt”) for representation of the data received and a hardware setting file (i.e. “RF_HW_Setting.txt”) for representation of the hardware setting thereto. In this embodiment, if a user request is received, the RF module can be controlled to transmit data by the transmission file (“RF_OUT.txt”) and which can be controlled to receive data by the receiving file (“RF_IN.txt”. And, hardware settings of the RF module can be configured by the hardware setting file (“RF_HW_Setting.txt”). By an initial module (i.e. “AP_RF.exe”) of the RF module which comprises information regarding the generation of configurations for the RF module, the transmission file (“RF_OUT.txt”), the receiving file (“RF_IN.txt”) and the hardware setting file (“RF_HW_Setting.txt”) can be generated.

Note that, in this embodiment, each resource has a corresponding initial module. However, in other embodiments, all configurations of resources can be combined into one initial module in which each of the resources has a corresponding entry representing the related configurations thereto in the initial module.

The generated initial modules and configurations are then stored into the non-volatile memory 110. When plugging into the host device, the initial modules are first activated or executed in the host device so that the configurations of each resource can be known by the host device.

In one embodiment, one initial module is capable of being executed in any host devices running the same OS environment, such as a Window-based OS environment. In another embodiment, more than one initial module may be created in the electronic device for execution in other host devices running different OS environments. For example, first and second initial modules AP1 and AP2 are created for execution in Window-based and Linux-based OS environments respectively. In such case, the type of the OS environment running in the host device (i.e. Window-based or Linux-based) is first determined and a corresponding initial module (i.e. AP1 or AP2) is then executed when plugged into the host device. For example, the first initial module AP1 or the second initial module AP2 will be activated when execution in Window-based or Linux-based OS environments respectively. With this configuration, ICs or devices developed by the vendor may be operated and controlled in different OS environments by simply modifying the applications of the initial module instead of developing new drivers corresponding to the running OS environment platform.

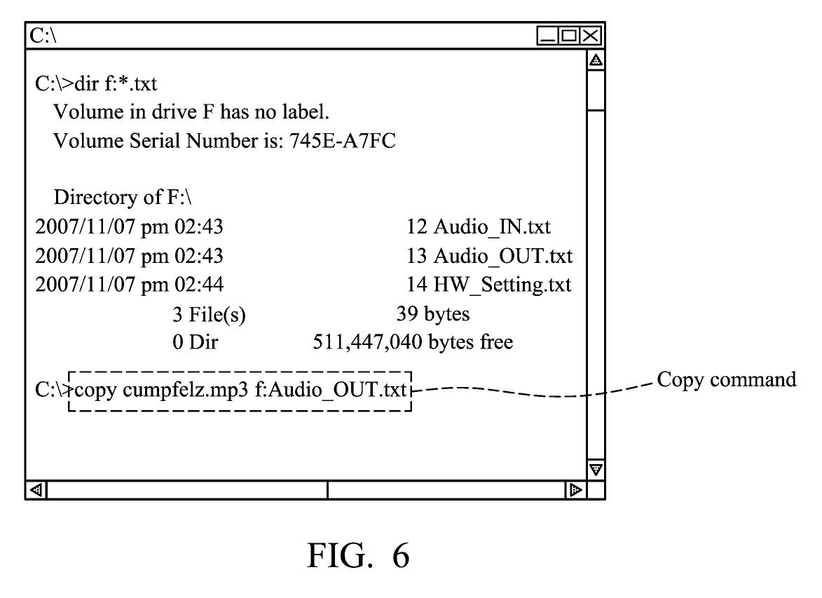

FIG. 5 is a flowchart of a method for performing a request to perform an operation in the plugged device, according to exemplary embodiments. In step S510, a request is generated by a user using a user interface or directly inputting instructions. The user interface (not shown) may be a graphic user interface (GUI) that provides function settings or operation settings capability for all resources corresponding to the electronic device for selection by a user to generate a required request. FIG. 6 shows an example of inputting a predetermined command in a command mode. In this embodiment, a user may generate a request capable of performing an operation in the plugged device by using the user interface provided or directly inputting commands relating to the operation being performed of the selected resource in the command mode (e.g. the copy command shown in FIG. 6). Then, in step S520, a configuration is assigned according to the user or AP's request. For example, the generated request may be converted so as to obtain and assign a corresponding configuration. Accordingly, in step S530, the request is sent to the plugged device. For example, the user may issue an audio playing request to the audio codec module for playing an audio file thereby by the provided user interface or manually performing a related copy command to Audio_OUT.txt(e.g. “copy cumpfelz.mp3 f: Audio_OUT.txt”).

FIG. 7 is another flowchart of a method for performing an operation in the plugged device, according to exemplary embodiments. In step S710, a request for configuring a specific resource from the host device is received by the electronic device. After receiving the request, in step S720, an operation of a corresponding resource is performed by the electronic device using a corresponding configuration. For example, referring to FIG. 4, user may generate an audio inputting request and input the audio file to be played to the audio codec module by the configuration “Audio_IN.txt” or may generate an audio playback request to the audio codec module to direct it to output the audio file by the configuration “Audio_OUT.txt”.

FIG. 8 shows another exemplary example for managing an electronic device plugged into a host device. In this embodiment, configurations are implemented as files and thus assignment of one configuration is equivalent to performing a file operation, read or write file, of a corresponding file. In another embodiment, the configurations may be implemented as folders and thus assignment of one configuration is equivalent to dragging data to or from a target or a source folder. Assume that an audio codec module may be operated by three files, files “Audio_IN.txt”, “Audio_OUT.txt” and “Audio_HW_Setting.txt” (e.g. as configurations shown in FIG. 4), for representation of inputting data to, outputting data by and configuring hardware setting features of the audio codec module respectively. “AP_Audio.exe” is an initial module which corresponds to the audio codec module and is capable of generating these three files when being activated. Similarly, assume that a RF module can be operated by three files, files “RF_Out.txt”, “RF_IN.txt” and “RF_HW_Setting.txt”, for controlling the RF module to transmit data, receive data and configure hardware setting features thereof respectively. “AP_RF.exe” is an initial module which corresponds to the RF module and is capable of generating these three files when being activated. Note that, when the electronic device is plugged into the host device via the connection interface, resources of which can not be normally utilized if no driver is installed in the plugged electronic device and no driver corresponding thereto can be found on the host device either. According to the invention, the initial modules “AP_Audio.exe” and “AP_RF.exe” are automatically activated and thus files “Audio_IN.txt”, “Audio_OUT.txt”, “Audio_HW_Setting.txt” and “RF_IN.txt”, “RF_OUT.txt”, “RF_HW_Setting.txt” are generated in the electronic device respectively when the electronic device is plugged into the host device via a connection interface (step S810). Then, a user may, in this embodiment, utilize a specific user interface or make a copy command shown in FIG. 6 to generate an audio_out request for directing the audio codec module in the plugged device to play an audio data (step S820). Note that the user may also utilize a file manger application as the user interface and drag the xx.mp3 file to the file “Audio_OUT.txt” to generate the audio_out request in a Window-based OS environment in another embodiment. The audio_out request is then sent to the plugged device (step S830). Upon receiving the audio_out request, the audio codec module is directed to play the audio file thereof using the file “Audio_OUT.txt” stored in the non-volatile memory of the plugged device (step S840). As the file “Audio_OUT.txt” corresponds to the output part of the audio codec module (e.g. the speaker), data within the received request (i.e. xx.mp3) is served as output data of the audio codec module and thus the xx.mp3 will be played by the audio codec module.

An advantage of the embodiment is that resources of the plugged device can be easily managed by the host device by using the assignment of configuration corresponding thereto, instead of installing drivers. Thus, no driver is needed for the plugged device and the same initial module may be applied to different vendors. Another advantage of the embodiment is that, one initial module can be applied to any other pluggable devices running in the same OS environment as the plugged device. Further, the proposed invention may provide a user mode design (e.g. using simple commands or user interface design) rather than a kernel mode design (e.g using a software development kit (SDK) for driver development), making the development and implementation of the pluggable devices more easier. Therefore, efficiently reducing the time spent on development for the pluggable devices and simplifying the manageability of the pluggable devices.

While the invention has been described by way of examples and in terms of preferred embodiments, it is to be understood that the invention is not limited thereto. Any variation or modification can be made by those skilled in art without departing from the spirit or scope of the invention. Therefore, the scope of the appended claims should be accorded the broadest interpretation to encompass all such modifications and similar arrangements.

What is claimed is:

1. An electronic device, comprising:
At least one resource;
A non-volatile memory, storing the configuration for the resource;
A connection interface; and
A processor, generating at least one corresponding configuration for the resource,
wherein the electronic device receives a request generated from a host device and performs an operation in the resource using the corresponding configuration.

2. The electronic device as claimed in claim 1, wherein the non-volatile memory further stores an initial module of the resource, and the initial module is automatically activated to generate the configuration of the resource when the electronic device is plugged into the host device.

3. The electronic device as claimed in claim 2, wherein the initial module is an application program containing information regarding the resource and the configuration corresponding thereto.

4. The electronic device as claimed in claim 2, wherein the processor further generates the configuration of the resource according to the functionality of the resource.

5. The electronic device as claimed in claim 4, wherein the electronic device further creates a first initial module for running in a first operating system (OS) environment and a second initial module for running in a second OS environment and determines to activate the first initial module or the second initial module when the host device is running in the first or second OS environment respectively, wherein the first OS is different from the second OS.

6. The electronic device as claimed in claim 2, wherein each configuration is implemented as a file.

7. The electronic device as claimed in claim 1, wherein the received request is generated by using a user interface or by manually inputting a predetermined command in the host device.

8. The electronic device as claimed in claim 1, wherein the non-volatile memory is a flash memory.

9. The electronic device as claimed in claim 1, wherein the electronic device is a driverless device and the resource is an audio codec module, a Global Positioning System (GPS) module, a card reader module, a wireless module or a finger recognized module and other I/O application module(includes above all devices).

10. The electronic device as claimed in claim 1, wherein the resource is selected from a groups of an audio codec module, a Global Positioning System (GPS) module, a card reader module, a wireless module, a finger recognition module and a handwriting recognition module and other I/O application module(includes above all devices).

11. A method for managing an electronic device plugged into a host, wherein the electronic device has at least one resource, and the method comprising:
generating at least one configuration for the resource when detecting that the electronic device is plugged into the host device; and
selecting the resource and directing the resource to perform an operation corresponding to the configuration using the configuration of the selected resource.

12. The method as claimed in claim 11, wherein the generating step further comprises:
automatically activating an initial module resident on the plugged electronic device in the host device; and
providing the configuration of the resource by the initial module.

13. The method as claimed in claim 12, further comprising:
providing the resource of the plugged device;
generating the configuration of the provided resource according to the functionality thereof; and
storing the generated configuration and the initial module in a non-volatile memory of the plugged device.

14. The method as claimed in claim 12, further comprising:
creating a first initial module for running in a first operating system (OS) environment and a second initial module for running in a second OS environment, wherein the first OS is different from the second OS; and
determining to activate the first initial module or the second initial module when the host device is running in the first or second OS environment, respectively.

15. The method as claimed in claim 12, wherein the initial module is an application program containing information regarding the resource and the generated configuration.

16. The method as claimed in claim 11, wherein the selecting step further comprises:
providing a user interface;
generating a request by the user interface; and
transmitting the generated request to the electronic device to direct the selected resource to perform the operation according to the configuration corresponding thereto.

17. The method as claimed in claim 11, wherein the selecting step further comprises:
generating a request by manually inputting a predetermined command; and
transmitting the generated request to the electronic device to direct the selected resource to perform the operation according to the configuration corresponding thereto.

18. The method as claimed in claim 11, wherein each configuration is implemented as a file.

19. A method for managing an electronic device, wherein the electronic device has at least one resource, and the method comprising:
providing at least one configuration for the resource;
plugging into a host device and generating the configuration for the resource;
receiving a request from the host device; and
performing an operation in a selected resource using the configuration corresponding to the selected resource.

20. The method as claimed in claim 19, further comprising:
providing at least one initial module for the resource; and
automatically activating the initial module to provide the configuration to the host device when plugged into the host device,
wherein the initial module contains information regarding the configuration corresponding to the resource.
